(19) United States
(12) Patent Application Publication
(10) Pub. No.: US 2009/0213598 A1
(43) Pub. Date: Aug. 27, 2009

(54) Wall mounted fixture for decoratively displaying an object

(76) Inventor: Thomas W. Terry, Sylmar, CA (US)

Correspondence Address: Robert Louis Finkel, P. O. Box 19276, Encino, CA, 91416, US

(21) Appl. No.: 12/072,378

(22) Filed: Feb. 27, 2008

(51) Int. Cl. F21S 8/08

(52) U.S. Cl. 362/419

(57) ABSTRACT

A fixture for decoratively displaying and illuminating an object, such as a guitar, includes a hanger adapted for attachment to a wall or other upstanding support. The hanger includes adjustable means for releasably supporting a guitar or other object. The fixture incorporates a lighting system having at least one light source carried on a malleable arm. The arm is adapted for positioning and aiming the light source and thereby controllably illuminating a hanging object. The lighting system includes an electric power source electrically connected to the light source through a switch. Electrical current control means may be provided for regulating the intensity of the light emitted by the light source. In a preferred embodiment, the lighting system includes a plurality of light sources mounted to the fixture on, and positioned and aimed by independently moveable elongated malleable arms.

### BACKGROUND OF THE INVENTION

1. Field of the Invention

The subject invention relates to a fixture for decoratively displaying an object, such as a guitar. More particularly, it pertains to a wall-mounted hanger having lighting means for decoratively displaying a hanging guitar or other object. Still more specifically, it concerns a device of this type incorporating a lighting system having one or more selectively positioned and aimed light sources for controllably illuminating the displayed guitar or object.

2. Prior Art

Long considered primarily as convenient means for storing musical instruments, such as guitars, mandolins, and occasionally, violins, for easy access, wall-mounted brackets of the types shown in U.S. Pat. Nos. 4,182,505, 5,941,490, 5,911,396, 6,091,008 and 6,231,018, and Design Patents Nos. Des. 281,576 and Des. 316,000 offered little incentive to the interior designer, artist and craftsperson to employ the wall bracket for aesthetic purposes, much less as a decorative art form. As a result of the Post-Modern Movement, however, eclectic wall hangings have become the new focus of the arts and architecture. Even the well worn, wall-mounted guitar awaiting the player's next “gig” is a thing of newly-recognized beauty and an object of attention and admiration. In the face of these radical changes in taste, the wall brackets and hangers of the cited prior art are not adequate for displaying today's wall-art. In the contemporary design world, illumination is an integral part of the decorative wall display.

Where gallery-style floodlights, spotlights, track-lighting, and the like are not available or convenient, the wall mounted light fixture has become the means of choice for decoratively illuminating and displaying works of the arts and crafts in residential, office, commercial and even gallery and museum installations. Increased popularity has created a growing demand for unique, aesthetically pleasing ways of lighting and showing today's objects d'arte.

The prior art is replete with wall mounted brackets and assemblies for lighting displayed items of interest. U.S. Pat. Nos. 3,642,238, 5,303,127, 5,309,333, 5,816,696, 5,904,257 and 6,203,179, and UK Patent Applications 2,252,150 and 2,358,461 are typical examples of these devices. For reasons which become apparent from even a brief examination the cited appliances suffer from deficiencies which render them undesirable or unacceptable for the present purpose. The principal one of these is the difficulty they pose the user in positioning and aiming the light source to illuminate the object as he or she desires. This invention has to do with improvements in such devices, and in particular improvements that overcome that difficulty.

It is recognized by those skilled in the art that there is an unfilled need for a wall-mounted fixture for decoratively illuminating and displaying a variety of objects. The subject invention satisfies that need.

### PERCEIVED ADVANTAGES OF THE INVENTION

Given the state of the prior art, one of the potential advantages of the subject invention is the provision of a family of durable, aesthetically attractive fixtures adapted for positioning on any convenient wall or supporting structure and affording means for readily displaying objects of varying configuration.

A second perceived advantage of the invention is the provision in such fixtures of illuminating means affording easy, unrestricted adjustability, whereby the user can select, modify and change the lighting effect at will to suit his or her mood or the requirements of the moment.

A more specific perceived advantage is the provision in such a device of lighting means affording the user the ability to adjust the position of, and to aim the light source so as to illuminate the displayed object to his or her taste.

The subject invention reflects a further perceived need for a wall mounted fixture that is inexpensive to manufacture, and requires a minimum of skill, time and effort to install and use.

Still another anticipated advantage is the provision of a novel basic construction adaptable for the illumination and display of objects of various configurations in virtually any residential, office, commercial, industrial, gallery or museum installation.

An overarching contemplated advantage of the invention is the provision of an improved, illuminating wall-mounting fixture of the type described here that avoids or overcomes the various defects and deficiencies of the prior art hangers and mounting brackets.

The subject invention is a hanger for holding and decoratively displaying an object, such as a guitar. In the preferred embodiments illustrated, the hanger is provided with anchors, such as screws, or other suitable means, for attachment to a wall or convenient upstanding support. The hanger includes one or more U- or otherwise appropriately-shaped protrusions, flanges, or extensions formed and positioned to receive and releasably support the neck of a guitar or some other convenient structural portion of a musical instrument or object. Conventionally, the supports are swiveled or otherwise adjustable to accommodate objects of various sizes and shapes.

Unlike the majority of well known prior art illuminated wall mounts and lighting fixtures, the subject invention incorporates lighting means intended and specifically adapted not for illuminating the hanger or an adjacent wall, bookshelf or area, but for controllably illuminating the guitar or other object hanging from it. And unlike the prior art illuminated wall mounts and lighting fixtures, the invention provides lighting means characterized by their effectiveness and their simplicity and ease of use.

The light source used is a matter of choice. Typical examples are high-intensity incandescent lamps, solid state lighting devices and fluorescent emitters. For purposes of this disclosure, it will be understood that when used to illuminate an object, the combination of a lamp and a fiber optic carrier is deemed to be a light source. In the prior art lighting devices, the light sources are mounted to or associated with rigid or semi-rigid light-supporting structures of one sort or another. In the preferred embodiment of this invention, the light source is carried on a narrow unsegmented malleable support arm, tube or stalk. (From time to time, these terms will be used interchangeably to describe a malleable, tentacle-like member capable of being formed easily to a desired shape by hand and having a memory allowing it to remain in that shape until it is re-formed.) Conveniently, the incandescent lamps, LEDs, or other light sources are integrated into the tips of the support arms. The invention contemplates and the specification discloses a number of constructions and configurations for the support arms.

The malleable flexible arm allows the user to both position and aim the light source so as to highlight the features of the hanging object to suit his or her aesthetic taste and the purpose of the display. (In this context, “position” is intended to mean selectively fix [the light source] at a location in a desired spatial relationship with the object to be illuminated. “Aim” is intended to mean orient [the light source] in an effort to maximize the intensity of the light impinging on the object.)

Preferably, a display hanger in accordance with the invention incorporates at least a pair of light sources mounted to independently movable support arms. Having a plurality of separately adjustable lights enables the user to create a variety of unique lighting effects.

In one of the illustrative embodiments, the hanger is relatively unadorned. As seen in another illustration, however, the invention lends itself to a broad spectrum of embellishments.

The lighting system includes an electric power source 61 electrically connected to the light sources through a switch and, where required, wiring running through the supporting arms. Power may be provided by internal storage batteries, or by house current supplied through a cable or conventional hard-wiring. Electrical current control means may be provided for regulating the current to, and thereby the intensity of the light emitted by the light sources.

In addition to those mentioned above, other perceived objects and features, advantages, and applications of the invention will become apparent from the following detailed description of the construction and operation of what are presently considered to be its preferred embodiments. Throughout the description, reference is made to the accompanying Drawing, in which:

### BRIEF DESCRIPTION OF THE DRAWING

FIG. 1 is a perspective view of a fanciful guitar hanger incorporating a typical prior art lighting system;

FIG. 2 is a perspective view of a preferred embodiment of a guitar hanger in accordance with the subject invention;

FIG. 3 is a perspective view of a guitar displayed on a hanger of the type illustrated in FIG. 2, with the hanger mounted to a column;

FIG. 4 is a simplified schematic of an electrical circuit for use in the hanger illustrated in FIG. 2;

FIG. 5 is a perspective view of another embodiment of the invention;

FIG. 6 is a fragmentary perspective view of a segment of a malleable light-supporting arm in accordance with the subject invention, with portions cut away to show its construction;

FIG. 7 is a fragmentary perspective view of a segment of an alternative form of malleable light-supporting arm in accordance with the subject invention, with portions cut away to show its construction; and

FIG. 8 is a fragmentary perspective view of a segment of another alternative form of malleable light-supporting arm in accordance with the subject invention, with portions cut away to show its construction.

Wherever practicable, like numerals are employed to designate like or functionally equivalent parts in the several figures.

### DETAILED DESCRIPTION OF THE PREFERRED EMBODIMENTS

The prior art contains numerous examples of sconces and wall-mounted lighting fixtures intended for illuminating hanging objects, such as paintings and other works of art, cabinets, book cases, tapestries, tools and equipment. Other luminaires are adapted to flood or wash walls and spaces with diffused light for viewing and aesthetic purposes. In both instances, designers, manufacturers and decorators, perceiving the need for solidity, employ rigid or semi-rigid construction as the standard for their lighting systems. While these systems may afford some degree of mobility or adjustability at installation, once in place and fixed, they are not easily moved or redirected.

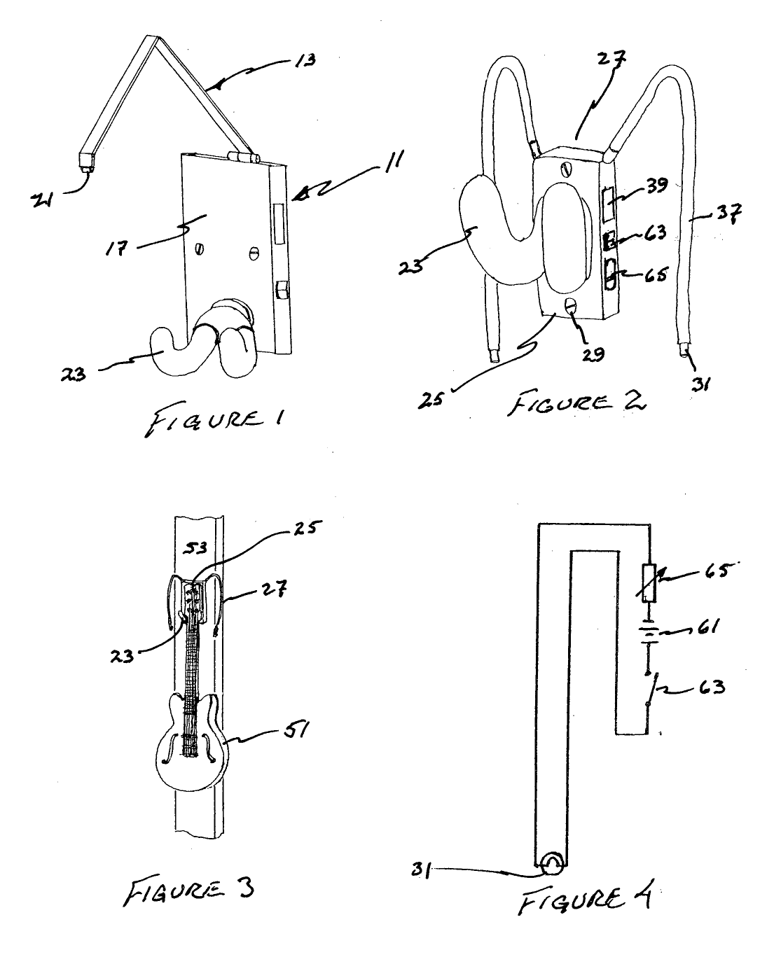

FIG. 1 illustrates a fanciful guitar hanger 11 as it might be constructed employing a typical prior art lighting system 13. The system 13 comprises a semi-rigid articulated, segmented arm 15 mounted by means of hinge 17 to the body 19 of hanger 11. A light source, such as high-intensity incandescent lamp 21, is mounted to the end of arm 15 to illuminate a guitar (not shown) suspended below the hanger 11 on supports 23. Because of the lateral rigidity of hinge 17 and the geometric constraints imposed by the articulation of arm 15, the amount and direction of illumination from Lamp 21 are severely limited. The user has virtually no control over the process. Mounting lamp 21 for rotation on arm 15 would do little to improve the situation. None of the known prior art rigid or semi-rigid support systems fully meets this deficiency.

The subject invention not only addresses but overcomes the problem. Referring to FIG. 2, the hanger 25 of fixture 27 embodying the subject invention employs a pair of sturdy, generally U-shaped cushioning supports 23 to securely and safely hold the neck of an electric or acoustic guitar, bass, mandolin or other stringed instrument. Supports 23 are swivelably and adjustably mounted to hanger 25 to receive instruments and objects of varying sizes and configurations. Anchor means, such as, screws 29 or other conventional mounting hardware are provided for securely fastening hanger 25 to a wall or other suitable upright surface or structure.

The subject invention is adaptable to any conventional integral or remote electrical incandescent, solid state, fluorescent, high-intensity discharge or hybrid light source. As will be seen, a fiber optic or other remote-transmission device can serve as a light source. Although in accordance with the invention a single light source will suffice for illuminating an instrument or object depending from the hanger 25, a pair of light sources afford the user more control over the lighting process and are preferable.

As seen in FIGS. 2 and 3, a pair of light sources 31, for example, single or arrayed LEDs are attached by conventional means (not shown) to the ends of a pair of narrow, elongated support arms 37. As will be described in greater detail shortly in connection with FIGS. 6-8, the arms 37 are formed with an axial bore 39 containing a central flexible mandrel 41. By virtue of their construction, arms 37 are malleable. That is, they can be readily formed to a desired shape by hand and retain that shape until they are reformed. The opposite ends of arms 37 are rigidly mounted to fixture 27 by means of appropriate connectors (not shown). In this manner, the light sources 31 are malleably supported by fixture 27.

Fixture 27 includes an internal source of electric power for operating the lighting system. The source may comprise D.C. storage batteries retained in a housing within fixture 27 and accessed through a removable cover 43 or A.C. house current supplied to internal circuitry (not shown) by a cord plugged into a convenient outlet or by hard wiring to a local circuit. In either case, the bores 39 in arms 37 provide convenient ducts for the electrical wiring carrying current from the power source 61 to light sources 31.

FIG. 3 illustrates a typical use of the embodiment shown in FIG. 2. Hanger 25 is anchored to a convenient upright structure, here a vertical column 51, by means of screws or other appropriate mounting hardware. The neck of a guitar 53 is inserted between the supports 23 of hanger 25 and secures the guitar 53 to hanger 25.

As depicted in the schematic of FIG. 4, the power source 61 (here one or more D.C. batteries) is electrically connected to the light sources (symbolically, 31) through a switch 63. A rheostat 65 allows the user to control the current to the light sources and thus the amount of light impinging on the guitar 51. When the user wishes to enhance the appearance of the guitar 53, he or she can activate switch 63 to send current to light sources 31. Grasping one or both of malleable support arms 37, the user manually positions each light source 31 precisely with respect to guitar 53. Depending on the mood, ambiance, circumstances and motivation of the moment, the user can adjust the rheostat 65 to provide the desired level of illumination. Further adjustments of light and shadow, highlights, focus and other aspects of the scene can be made by maintaining the position of each of the light sources 31 with one hand while carefully aiming it with the other hand to achieve the result sought. Once the adjustments have been made, the rigidity of the malleable arms 37 will retain the “settings” until they are changed by the user or someone with his or her permission.

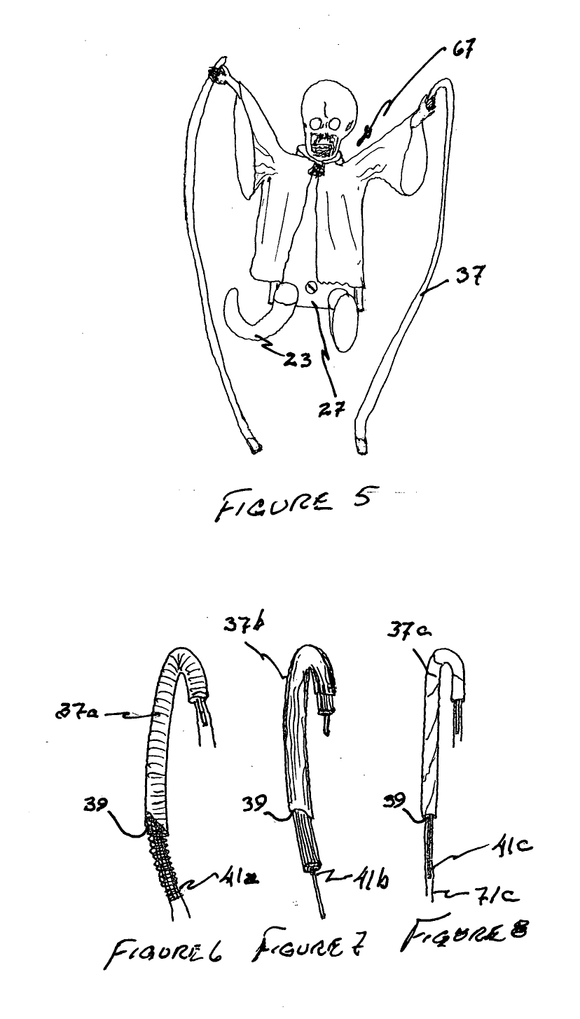

FIG. 5 illustrates the decoration of a fixture 27 embodying the invention to provide an ornamental background 67 for the guitar 53 or other object being displayed. If desired, one could provide a number of fixtures 27 with varied designs and ornamentation for use with a single, reusable hanger 25, thereby allowing the user to effectively change the ambience as well as the illuminated display at will.

Turning to FIGS. 6-8, supports 23 can employ a variety of constructions. By way of a few examples, the malleable element 37a of FIG. 6 is formed by utilizing a mandrel 41a incorporating an armature or tightly-wound helix of relatively fine copper, soft steel, aluminum or other suitable wire enclosed in a pliable protective sheath of natural or synthetic material providing a visually attractive appearance.

The support 37b of FIG. 7 comprises a bundle of light-transmitting fibers having a metallic or synthetic core 41b embedded to provide the desired degree of “memory.” In this instance, the electrical wiring runs entirely within fixture 27 from the power source 61 and switch 63 to the lamp within fixture 27 (not shown) producing the light transmitted by the bundle of optical fibers. The bore 39 would not be used.

In the embodiment of FIG. 8, arm 37 is formed by wrapping the wire mandrel 41c and electrical wires 71c in a sheet, or inserting them in a tube of polyolefin plastic or similar heat-shrink material and heating the assembly to produce a tightly compressed but still malleable tubular element.

By virtue of the foregoing design and construction features, the subject invention provides substantial advantages over the prior art illuminated wall mounts and lighting fixtures. Its use of malleable support arms rather than rigid or semi-rigid articulated structures affords the user far greater ease and flexibility in the illumination of his or her instrument or object. The subject invention is demonstrably more effective than any of the prior art devices in providing decorative illumination for a hanging object. Unlike any of the prior art lighting systems, it affords the user virtually unlimited freedom to develop new and novel lighting techniques and effects.

The utility and benefits afforded by the invention will be readily apparent from the foregoing disclosure. It should be understood, however, that although the invention has been disclosed in terms of the specific constructions shown in the drawing and described in the text, it is not to be construed as limited to those embodiments. They are to be regarded as illustrative rather than restrictive. This specification is intended to encompass any and all variations, alternative forms, and equivalents of the examples chosen for purposes of the disclosure, which do not depart from the spirit and scope of the invention as it is defined by the following claims.

What is claimed is:

1. A fixture for decoratively displaying an object, comprising:
a hanger for releasably supporting an object;
anchor means for attaching said hanger to an upstanding support;
a light source;
a malleable arm mounting said light source to said fixture for positioning and aiming said light source and thereby controllably illuminating a hanging object.

2. The fixture of claim 1, wherein said malleable arm has a bore.

3. The fixture of claim 2, wherein the bore contains a flexible mandrel.

4. The fixture of claim 3, including an electric power source electrically connected to the light source through a switch.

5. The fixture of claim 4, wherein the bore contains electrical wiring connecting the electric power source to the light source.

6. The fixture of claim 5, including electrical current control means for regulating the current to, and thereby the intensity of the light emitted by the light source.

7. The fixture of claim 1, comprising:
a plurality of light sources each having an independently moveable malleable arm mounting it to said hanger for positioning and aiming said light source and thereby controllably illuminating a hanging object; and
an electric power source electrically connected to said light sources through a switch.

8. A wall mounted fixture for decoratively displaying an object, comprising:
an object-supporting hanger;
mounting means for securing said hanger to an upstanding support;
a plurality of light sources, each of the light sources being mounted to said fixture on an independently movable malleable arm for positioning and aiming the light source and thereby controllably illuminating a hanging object; and
an electric power source electrically connected to said light source through a switch.

9. The fixture of claim 8, wherein each said malleable arm has a bore.

10. The fixture of claim 9, wherein each bore contains a flexible mandrel.

11. The fixture of claim 10, wherein each bore contains electrical wiring connecting the electric power source to the light source.

12. The fixture of claim 8, wherein the lighting system includes electrical current control means for regulating the current to, and thereby the intensity of the light emitted by the light source.

13. A fixture for decoratively illuminating and displaying an object, said fixture comprising:
a hanger having object-engaging means for releasably supporting an object, said object-engaging means being adjustable to support objects of varying configuration;
mounting means for securing the hanger to an upstanding support; and
a lighting system including at least one light source mounted to said fixture on a malleable arm for positioning and aiming said light source and thereby controllably illuminating a hanging object, said lighting system further including an electric power source electrically connected to the light source through a switch and electrical current control means for regulating the current to, and thereby the intensity of the light emitted by the light source.

14. In combination with a fixture for decoratively illuminating and displaying an object, said fixture comprising:
a hanger having object-engaging means for releasably supporting an object, said object-engaging means being adjustable to support objects of varying configuration;
mounting means for securing the hanger to an upstanding support; and
a lighting system including at least one light source mounted to said fixture on a malleable arm for positioning and aiming said light source and thereby controllably illuminating a hanging object, said lighting system further including an electric power source electrically connected to the said at least one light source through a switch, and electrical current control means for regulating the current to, and thereby the intensity of the light emitted by the at least one light source;
an object.
